(19) United States
(12) Patent Application Publication
(10) Pub. No.: US 2019/0147851 A1
(43) Pub. Date: May 16, 2019

(54) INFORMATION PROCESSING APPARATUS, INFORMATION PROCESSING SYSTEM, INFORMATION PROCESSING METHOD, AND STORAGE MEDIUM WHICH STORES INFORMATION PROCESSING PROGRAM THEREIN

(71) Applicant: SHARP KABUSHIKI KAISHA, Sakai City (JP)

(72) Inventors: HIDEAKI KIZUKI, Sakai City (JP); AKIRA WATANABE, Sakai City (JP); YURI IWANO, Sakai City (JP)

(21) Appl. No.: 16/188,915

(22) Filed: Nov. 13, 2018

(30) Foreign Application Priority Data
Nov. 15, 2017 (JP) 2017-220103

(51) Int. Cl. G10L 15/00; G10L 15/26; G10L 13/08; G10L 15/22

(52) U.S. Cl. CPC G10L 15/005; G10L 15/22; G10L 13/086; G10L 15/265

(57) ABSTRACT

In order to output a message in the language used by an operator even if speech recognition fails, provided is an arrangement configured to: obtain input speech information related to user's speech; and select a first response or a second response with reference to the input speech information thus obtained, the first response being a response for carrying out an interaction with a user, the second response being a response for prompting the user to speak again, the arrangement configured to, if selection of the second response is to be carried out before start of the interaction with the user, determine a detail of the second response according to an attribute of the user determined with reference to the input speech information.

This Nonprovisional application claims priority under 35 U.S.C. § 119 on Patent Application No. 2017-220103 filed in Japan on Nov. 15, 2017, the entire contents of which are hereby incorporated by reference.

### TECHNICAL FIELD

The present invention relates to an information processing apparatus, an information processing system, an information processing method, and a storage medium which stores an information processing program therein.

### BACKGROUND ART

The following technique has been known: a technique to recognize a speech of an operator, determine in what language the input speech was made, and output a message in the determined language to the operator (for example, see Patent Literature 1).

### CITATION LIST

### Patent Literature

[Patent Literature 1]

Japanese Patent Application Publication Tokukai No. 2001-175278 (Publication date: Jun. 29, 2001)

### SUMMARY OF INVENTION

### Technical Problem

However, conventional techniques like that described above have an issue in that, if the speech recognition fails, it is not possible to output a message in the language used by the operator.

An object of one or more embodiments of the present invention is to provide a technique that is capable of, even if the speech recognition fails, outputting a message in the language used by the operator.

### Solution to Problem

In order to attain the above object, an information processing apparatus according to one or more embodiments of the present invention includes: a speech information obtaining section; a speech information presenting section; and a control section, the control section being configured to obtain input speech information related to a speech of a user via the speech information obtaining section, select a first response or a second response with reference to the input speech information thus obtained, the first response being a response for carrying out an interaction with the user, the second response being a response for prompting the user to speak again, and present, via the speech information presenting section, output speech information related to the first or second response thus selected, the control section being configured to, if selection of the second response is to be carried out before start of the interaction with the user, determine a detail of the second response according to an attribute of the user determined with reference to the input speech information

### Advantageous Effects of Invention

According to one or more embodiments of the present invention, it is possible, even if speech recognition fails, to output a message in the language used by an operator.

### BRIEF DESCRIPTION OF DRAWINGS

FIG. 1 is a block diagram schematically illustrating a configuration of an information processing system in accordance with Embodiment 1.

FIG. 2 is a block diagram schematically illustrating a configuration of an information processing system in accordance with Embodiments 2 and 3.

FIG. 3 is a block diagram schematically illustrating a configuration of an information processing system in accordance with Embodiment 4.

FIG. 4 is a flowchart illustrating a flow of a process carried out by the information processing system in accordance with Embodiment 4.

FIG. 5 illustrates an example of a first response group.

FIG. 6 is a block diagram schematically illustrating a configuration of an information processing system in accordance with Embodiment 5.

FIG. 7 is a block diagram exemplarily illustrating a configuration of a computer that can be used as an information processing apparatus.

### DESCRIPTION OF EMBODIMENTS

### Embodiment 1

The following description will discuss Embodiment 1 of the present invention in detail.

[Overview of Information Processing System]

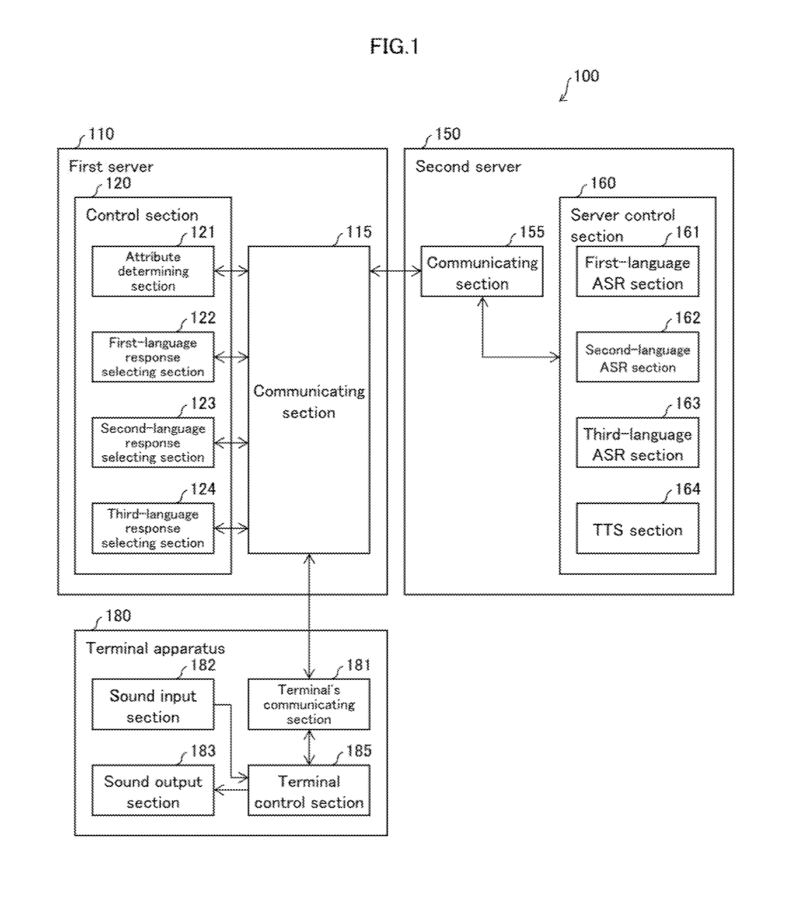

FIG. 1 is a block diagram schematically illustrating a configuration of an information processing system 100 in accordance with Embodiment 1. As illustrated in FIG. 1, the information processing system 100 includes a first server (information processing apparatus) 110, a second server 150, and a terminal apparatus 180.

The information processing system 100 is configured to carry out audio interactions with a user in the following manner: a sound of a speech of the user is input to the terminal apparatus 180; the first server 110 and the second server 150 process the sound of the speech to produce a response sound; and the response sound is output from the apparatus 180.

(Configuration of Terminal Apparatus 180)

The terminal apparatus 180 includes a terminal control section 185, a terminal's communicating section 181, a sound input section 182, and a sound output section 183.

The terminal control section 185 is an arithmetic unit which serves as a control section to control various sections of the terminal apparatus 180 in an integrated manner. The terminal control section 185 controls the constituent elements of the terminal apparatus 180 by, for example, executing, by one or more processors (e.g., CPU), programs stored in one or more memories (e.g., RAM, ROM).

The terminal's communicating section 181 is configured to be communicable with external apparatuses, and includes a wireless communication circuit such as Wi-Fi (registered trademark).

The sound input section 182 transmits input speech information related to a speech of a user (this information is hereinafter referred to as input speech information related to user's speech) to an external apparatus via the terminal's communicating section 181. The input speech information, which is transmitted to the external apparatus via the terminal's communicating section 181, may be raw sound data, or may be data resulting from speech recognition, such as text information. Alternatively, the sound input section 182 may be arranged to: collect a voice of the user; convert the collected voice into electronic waveform data; and transmit, to an external apparatus via the terminal's communicating section 181, the waveform data as the input speech information related to user's speech.

The sound output section 183 outputs sound data in the form of sound waves. In Embodiment 1, the sound output section 183 outputs a sound that falls within the sonic range audible to the human ear. The sound output section 183 carries out streaming output of a sound based on sound data obtained from an external apparatus via the terminal's communicating section 181. The sound output section 183 may be configured to: obtain output speech information (which is presented via a communicating section 115 of the first server 110) via the terminal's communicating section 181; and carries out streaming output of a sound based on the output speech information. The output speech information may be raw sound data, or may be data for use in speech synthesis, such as text information, and the sound output section 183 may have the function of carrying out speech synthesis.

The terminal apparatus 180 may include a display section that displays text messages and images, and may be configured to carry out “interaction” with the user by causing the display section to display, in text form, output information obtained from the communicating section 115 of the first server 110 via the terminal's communicating section 181 (this arrangement is not illustrated).

(Configuration of First Server 110)

The first server 110 includes the communicating section 115 and a control section 120.

The communicating section 115 is configured to be communicable with external apparatuses, and includes a wireless communication circuit such as Wi-Fi (registered trademark). The first server 110 communicates with the terminal apparatus 180 and the second server 150 via the communicating section 115. The communicating section 115 receives, from the terminal's communicating section 181 of the terminal apparatus 180, waveform data based on the voice of the user. In a case where the first server 110 (serving as an information processing apparatus) resides on a server on a network, the communicating section 115 serves as a speech information obtaining section to obtain speech information which is waveform data based on the voice of the user, as described above. Note that, in a case where the functions of the information processing system 100 are achieved by a single apparatus, the sound input section 182, instead of the communicating section 115, may serve as the speech information obtaining section.

The communicating section 115 transmits, to the second server 150, the waveform data based on the voice of the user received from the terminal apparatus 180. The communicating section 115 also receives, from the second server 150, processed data resulting from processing of the waveform data by the second server 150.

The communicating section 115 also transmits, to the terminal apparatus 180, a response phrase in the form of a sound received from the second server 150. In a case where the first server 110 (serving as the information processing apparatus) resides on a server on a network, the communicating section 115 serves as a speech information presenting section to present a response phrase in the form of a sound, as described above. Note that, in a case where the functions of the terminal apparatus 180 and the first server 110 or all the functions of the information processing system 100 are achieved by a single apparatus, the sound output section 183, instead of the communicating section 115, may serve as the speech information presenting section. The sound output section 183, which serves as the speech information presenting section, may be a display section that displays output information in text form. The following descriptions in Embodiment 5 will specifically discuss a configuration in which the functions of the terminal apparatus 180 and the first server 110 are achieved by a single apparatus.

The control section 120 is an arithmetic unit which serves to control various sections of the first server 110 in an integrated manner. The control section 120 controls the constituent elements of the first server 110 by, for example, executing, by one or more processors (e.g., CPU), programs stored in one or more memories (e.g., RAM, ROM).

The control section 120 includes an attribute determining section 121 and one or more response selecting sections.

The attribute determining section 121 determines an attribute of the user with reference to the input speech information related to user's speech, which is obtained from the terminal apparatus 180 via the communicating section 115. The attribute determining section 121 determines, for example, at least either the language used by the user or hometown of the user. For example, the attribute determining section 121 determines the language used by the user with reference to the input speech information related to user's speech. Alternatively, the attribute determining section 121 may be capable of determining at least one of the following: dialect (accent) of the user; age of the user; and gender of the user, with reference to waveform data based on the voice of the user. Alternatively, the attribute determining section 121 may be capable of determining the emotional state of the user.

The attribute determining section 121 may carry out a determination based on the waveform data via machine learning. Alternatively, the attribute determining section 121 may determine an attribute of the user by comparing base data for each attribute with the waveform data based on the voice of the user. Alternatively, the attribute determining section 121 may be configured to: calculate the degree of similarity between the waveform data based on the voice of the user and waveform data of base data of each of two or more languages by comparing the waveform data based on the voice of the user with the waveform data of the base data of each of the two or more languages; and determine whether or not the degree of similarity is equal to or greater than a predetermined threshold.

The one or more response selecting sections are provided for respective language(s) supported by the first server 110. FIG. 1 exemplarily illustrates a configuration in which the first server 110 supports three languages: a first language; a second language; and a third language, and in which the control section 120 includes a first-language response selecting section 122, a second-language response selecting section 123, and a third-language response selecting section 124.

The first-language response selecting section 122, the second-language response selecting section 123, and the third-language response selecting section 124 each use text matching against a static or dynamic text dictionary to specify a user phrase spoken by the user. The first-language response selecting section 122, the second-language response selecting section 123, and the third-language response selecting section 124 each determine, based on the degree of text similarity, the degree of matching between the user phrase and the text dictionary. This determination is carried out using a known method such as edit distance.

The first-language response selecting section 122, the second-language response selecting section 123, and the third-language response selecting section 124 each select a response phrase corresponding to the specified user phrase. Note that the first-language response selecting section 122, the second-language response selecting section 123, and the third-language response selecting section 124 may each determine that no corresponding response phrases exist, depending on the specified user phrase.

(Configuration of Second Server 150)

The second server 150 includes a communicating section 155 and a server control section 160.

The communicating section 155 is configured to be communicable with external apparatuses, and includes a wireless communication circuit such as Wi-Fi (registered trademark). The second server 150 communicates with the first server 110 via the communicating section 155.

The server control section 160 is an arithmetic unit which serves to control various sections of the second server 150 in an integrated manner. The server control section 160 controls the constituent elements of the second server 150 by, for example, executing, by one or more processors (e.g., CPU), programs stored in one or more memories (e.g., RAM, ROM).

The server control section 160 includes: one or more automatic speech recognition (ASR) sections each serving as a speech recognition section; and a text-to-speech (TTS) section 164 serving as a speech synthesis section.

The one or more ASR sections are provided for respective language(s) supported by the second server 150. For example, in a case where the second server 150 supports three languages such as the first language, the second language, and the third language, the server control section 160 is configured such that a first-language ASR section 161, a second-language ASR section 162, and a third-language ASR section 163 are included, as illustrated in FIG. 1.

The first-language ASR section 161, the second-language ASR section 162, and the third-language ASR section 163 each carry out speech recognition of the waveform data based on the voice of the user, which is obtained from the first server 110 via the communicating section 155, and thereby convert the waveform data into text. The first-language ASR section 161, the second-language ASR section 162, and the third-language ASR section 163 may each be configured to, when carrying out speech recognition of the waveform data based on the voice of the user to convert the waveform data into text, calculate a degree of confidence as an attribute.

The server control section 160 may be configured such that: one of the first- to third-language ASR sections 161, 162, and 163 is selected according to the language determined by the attribute determining section 121 of the first server 110; and speech recognition is carried out by the selected one of the ASR sections. Alternatively, the server control section 160 may be configured such that the waveform data based on the voice of the user obtained from the first server 110 is passed through the first-language ASR section 161, the second-language ASR section 162, and the third-language ASR section 163 serially or in a parallel manner to be processed.

The TTS section 164 converts text into sound. The TTS section 164 converts the response phrase in text form, which has been selected by at least one of the first- to third-language response selecting sections 122, 123, and 124 and which has been obtained from the first server 110 via the communicating section 155, into a sound. The response phrase, which has been converted into a sound by the TTS section 164, is transmitted to the first server 110 via the communicating section 155.

[Multilingual Interaction Process]

Upon receiving the sound of the speech of the user via the sound input section 182, the terminal control section 185 obtains the input speech information related to user's speech with reference to an input to the sound input section 182. The terminal control section 185 transmits the obtained input speech information to the first server 110 via the terminal's communicating section 181.

The control section 120 of the first server 110 obtains the input speech information related to user's speech via the communicating section 115 (serving as the speech information obtaining section), and determines an attribute of the user through use of the function of the attribute determining section 121. For example, the attribute determining section 121 determines the language used by the user, and transmits the determined language and the input speech information related to user's speech to the second server 150 via the communicating section 115.

The server control section 160 of the second server 150 converts, with reference to information concerning the user's attribute obtained via the communicating section 155, the input speech information related to user's speech into a user phrase in text form, through use of the speech recognition function of at least one of the first- to third-language ASR sections 161, 162, and 163.

The server control section 160 may be configured such that the ASR section, which corresponds to the language that is determined by the attribute determining section 121 to be most similar to the language used by the user, is used to carry out the speech recognition. Alternatively, the server control section 160 may be configured such that, based on the degree of language similarity to each language calculated by the attribute determining section 121, an ASR section(s) for a language(s) that has a degree of language similarity of equal to or greater than a predetermined threshold is/are used to carry out the speech recognition.

The server control section 160 transmits the user phrase in text form, which has been produced through use of the function of at least one of the first- to third-language ASR sections 161, 162, and 163, to the first server 110 via the communicating section 155. Note that the first-language ASR section 161, the second-language ASR section 162, and the third-language ASR section 163 may each be configured to, when carrying out conversion of the input speech information related to user's speech into the user phrase in text form, calculate the degree of confidence of text, and the server control section 160 may be configured to transmit the degree of confidence of text, together with the user phrase in text form, to the first server 110.

The control section 120 of the first server 110 obtains the user phrase in text form via the communicating section 115. The control section 120 specifies the user phrase through use of the function of one of the first- to third-language response selecting sections 122, 123, and 124 that corresponds to the language of the user phrase in text form, and selects a response phrase in text form corresponding to the user phrase and a scenario of a conversation with the user.

The control section 120 is configured to, in a case where the user phrase in text form obtained via the communicating section 115 is in two or more languages, use each of two or more of the first- to third-language response selecting sections 122, 123, and 124, which correspond to the respective two or more languages, to specify the user phrase, and select a response phrase in text form corresponding to the user phrase and a scenario of a conversation with the user. The first-language response selecting section 122, the second-language response selecting section 123, and the third-language response selecting section 124 are each configured to, with reference to the degree of text similarity between the user phrase in text form and the specified user phrase and with reference to the degree of confidence of text received together with the user phrase in text form from the second server 150, select an appropriate response phrase in text form.

Note that each of the response selecting sections 122, 123, and 124 may be configured to be capable of selecting a response phrase corresponding to any of various user attributes such as dialect, gender, age, and emotional state, as with the language used by the user determined by the attribute determining section 121.

The control section 120 transmits the selected response phrase in text form to the second server 150 via the communicating section 115.

The server control section 160 of the second server 150 obtains the response phrase in text form via the communicating section 155, and converts the response phrase into a sound through use of the function of the TTS section 164. The server control section 160 transmits the response phrase in the form of a sound to the first server 110 via the communicating section 155.

The control section 120 of the first server 110 transmits the response phrase in the form of a sound (i.e., output speech information), which has been received from the second server 150, to the terminal apparatus 180 via the communicating section 115 (serving as the speech information presenting section).

The terminal control section 185 of the terminal apparatus 180 obtains the output speech information via the terminal's communicating section 181 and, with reference to the obtained output speech information, causes the sound output section 183 to output a sound. The terminal control section 185 causes the sound output section 183 to carry out streaming output of a sound based on the output speech information.

According to these configurations, it is possible to output a message in the language used by the user, without the need for prior information such as a language selection.

### Embodiment 2

The following description will discuss Embodiment 2 of the present invention. For convenience of description, members having functions identical to those of Embodiment are assigned identical referential numerals and their descriptions are omitted.

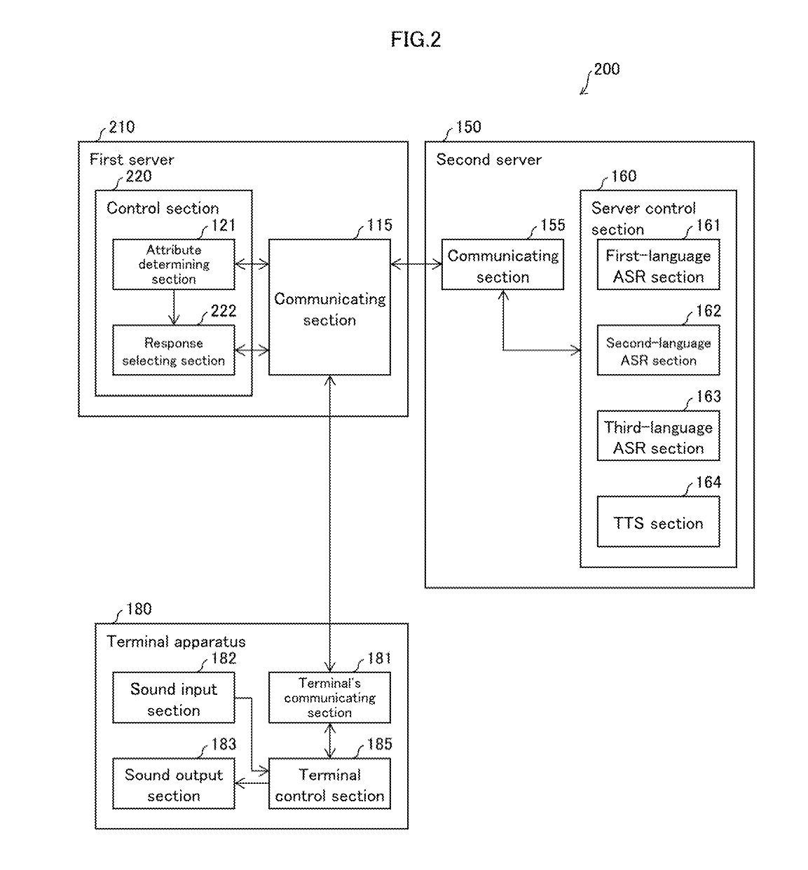

FIG. 2 is a block diagram schematically illustrating a configuration of an information processing system 200 in accordance with Embodiment 2. As illustrated in FIG. 2, the information processing system 200 is different from that of Embodiment 1 in that a response selecting section 222 of a control section 220 of a first server 210 is configured to carry out response selections corresponding to all the supported languages, instead of including response selecting sections corresponding to the respective supported languages.

Upon obtaining a user phrase in text form via the communicating section 115, the control section 220 of the first server 210 carries out text matching of the text against all the supported languages through use of the function of the response selecting section 222.

The response selecting section 222 selects a suitable response language and a response phrase with reference to the degree of text similarity between the user phrase in text form and a specified user phrase. Note that the response selecting section 222 may be configured to select a suitable response language and a response phrase with reference to the degree of confidence calculated by an ASR section(s), the degree of language similarity calculated by the attribute determining section 121, and/or the like, in addition to the degree of text similarity.

Alternatively, the response selecting section 222 may be configured to be capable of selecting a response phrase corresponding to any of various user attributes such as dialect, gender, age, and emotional state, as with the language used by the user determined by the attribute determining section 121.

The control section 220 transmits information about the selected response language and the response phrase in text form to the second server 150 via the communicating section 115.

The server control section 160 of the second server 150 obtains the response phrase in text form via the communicating section 155, and converts the response phrase into a sound in the selected response language through use of the function of the TTS section 164. The server control section 160 transmits the response phrase in the form of a sound to the first server 210 via the communicating section 155.

The control section 220 of the first server 210 transmits the response phrase in the form of a sound, which has been obtained from the second server 150, to the terminal apparatus 180 via the communicating section 115.

The terminal apparatus 180 receives the response phrase in the form of a sound via the terminal's communicating section 181, and causes the sound output section 183 to carry out streaming output of the received response phrase.

According to these configurations, the user phrase in text form, which has been obtained through ASR, is subjected to text matching, and thereby the language used by the user can be estimated. As such, it is possible to output a message in the language used by the user, without the need for prior information such as a language selection.

### Embodiment 3

The following description will discuss Embodiment 3 of the present invention. For convenience of description, members having functions identical to those of Embodiments 1 and 2 are assigned identical referential numerals and their descriptions are omitted.

An information processing system 200 in accordance with Embodiment 3 has the same configuration as the information processing system 200 of Embodiment 2 illustrated in FIG. 2, and therefore its descriptions are omitted here.

There may be cases in which, after the text matching of a user phrase in text form obtained via the communicating section 115 is carried out against all the supported languages through use of the function of the response selecting section 222, the user phrase is determined to be sufficiently similar to two or more languages. In such cases, the first server 210 of the information processing system 200 in accordance with Embodiment 3 carries out the following process.

The response selecting section 222 of the control section 220 multiplies, by the degree of confidence calculated by an ASR section(s), the degree of text similarity between the user phrase specified via text matching and text of each language, to thereby specify the language of the user phrase.

Alternatively, the response selecting section 222 of the control section 220 may select a user phrase in the language that has the highest degree of language similarity as calculated by the attribute determining section 121, among two or more languages that have been determined by text matching to have a sufficient degree of similarity.

Alternatively, the response selecting section 222 may be configured to be capable of selecting a response phrase corresponding to any of various user attributes such as dialect, gender, age, and emotional state, as with the language used by the user determined by the attribute determining section 121.

According to these configurations, it is possible to output a message in the language used by the user, without the need for prior information such as a language selection.

### Embodiment 4

The following description will discuss Embodiment 4 of the present invention. For convenience of description, members having functions identical to those of Embodiment 1 are assigned identical referential numerals and their descriptions are omitted.

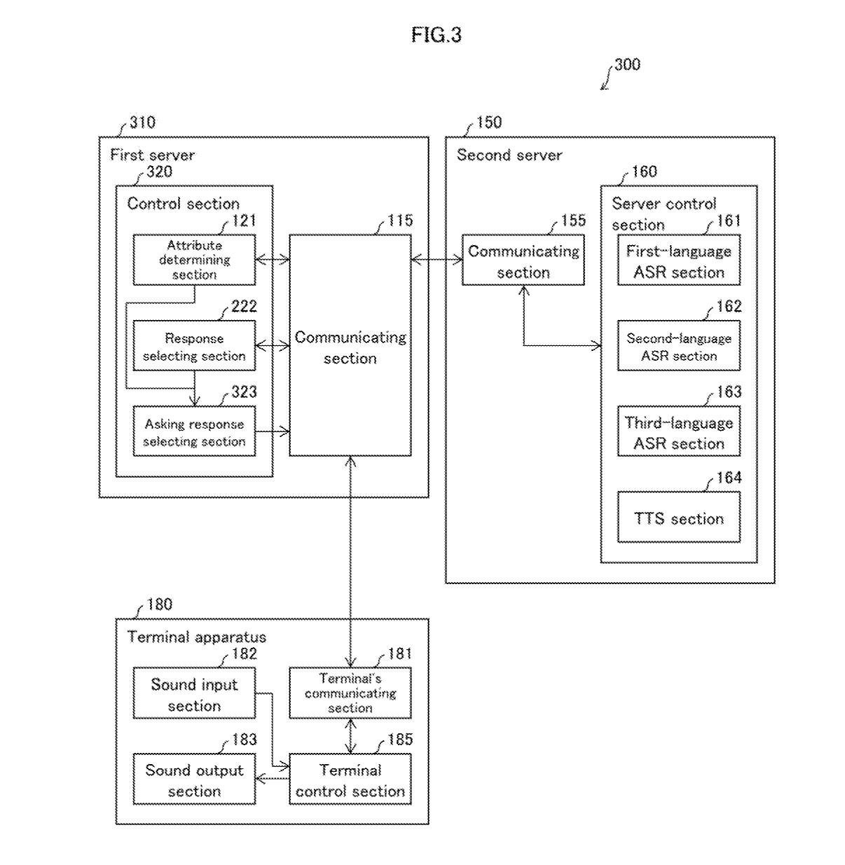

FIG. 3 is a block diagram schematically illustrating a configuration of an information processing system 300 in accordance with Embodiment 4. As illustrated in FIG. 3, the information processing system 300 is different from the information processing system 200 in accordance with Embodiment 2 in that a control section 320 of a first server 310 includes an asking response selecting section 323.

The response selecting section 222 selects a first response for carrying out an interaction with the user from a first response group that is pre-stored in a memory section (not illustrated) of the first server 310. FIG. 5 illustrates one example of the first response group.

The asking response selecting section 323 is configured to, if the response selecting section 222 fails to select from the first response group any response to the input speech information related to user's speech obtained via the communicating section 115 (serving as the speech information obtaining section), select an asking response that informs the user of the failure of the first response selection or a response that prompts the user to speak again, from second responses included in an asking response group different from the first response group. The expression “the response selecting section 222 fails to select any response to the input speech information related to user's speech” refers to, for example, a case in which, as a result of text matching against two or more languages, no matches are found (i.e., none of the phrases are found to have a degree of text similarity equal to or greater than a predetermined threshold), and the user phrase or the language used by the user cannot be specified.

The asking response selecting section 323 selects, from the asking response group, a phrase such as “Mou ichido itte kudasai” in the language that has been determined by the attribute determining section 121 to be the language used by the user (if the language used by the user has been determined to be English, the phrase “Could you say that again?” is selected). The asking response group may include not only the second responses each of which prompts the user to speak again, such as “Could you say that again?”, but also a response such as “I don't understand”.

Alternatively, the asking response selecting section 323 may be configured to, with reference to the degree of text similarity calculated by the response selecting section 222 and with reference to the determination by the attribute determining section 121, select the phrases “Could you say that again?” in two or more languages as second responses that prompt the user to speak again, thereby prompting the user to speak again in the two or more languages sequentially.

The asking response selecting section 323 may be configured to select a second response and/or to change the tone and/or volume of the second response according to various attributes of the user estimated by the attribute determining section 121, as with the language used by the user. For example, in a case where it is determined that the user used Queen's English, the asking response selecting section 323 may select a phrase and intonation in Queen's English. In a case where it is determined that the user is a child, the asking response selecting section 323 may select a phrase for children such as “Can you say that again?” instead of the phrase “Could you say that again?”. In a case where it is determined that the user is an elderly person, the asking response selecting section 323 may increase the sound level of the second response. Alternatively, the asking response selecting section 323 may be configured such that the second response is output in a voice of a different gender from the estimated gender of the user, for example, in a female voice if the user's gender is determined to be male and in a male voice if the user's gender is determined to be female.

Alternatively, the asking response selecting section 323 may be configured such that a second response is spoken in a way that varies depending on the emotional state of the user estimated by the attribute determining section 121. For example, the response selecting section 323 may be configured such that, if the user speaks pleasantly, the second response is output (spoken) pleasantly to sympathize with the happy feelings of the user. The asking response selecting section 323 may be configured such that, if the user speaks angrily, a second response with a polite phrase is selected and the selected second response is output (spoken) softly.

[Process Carried Out by Information Processing System 300]

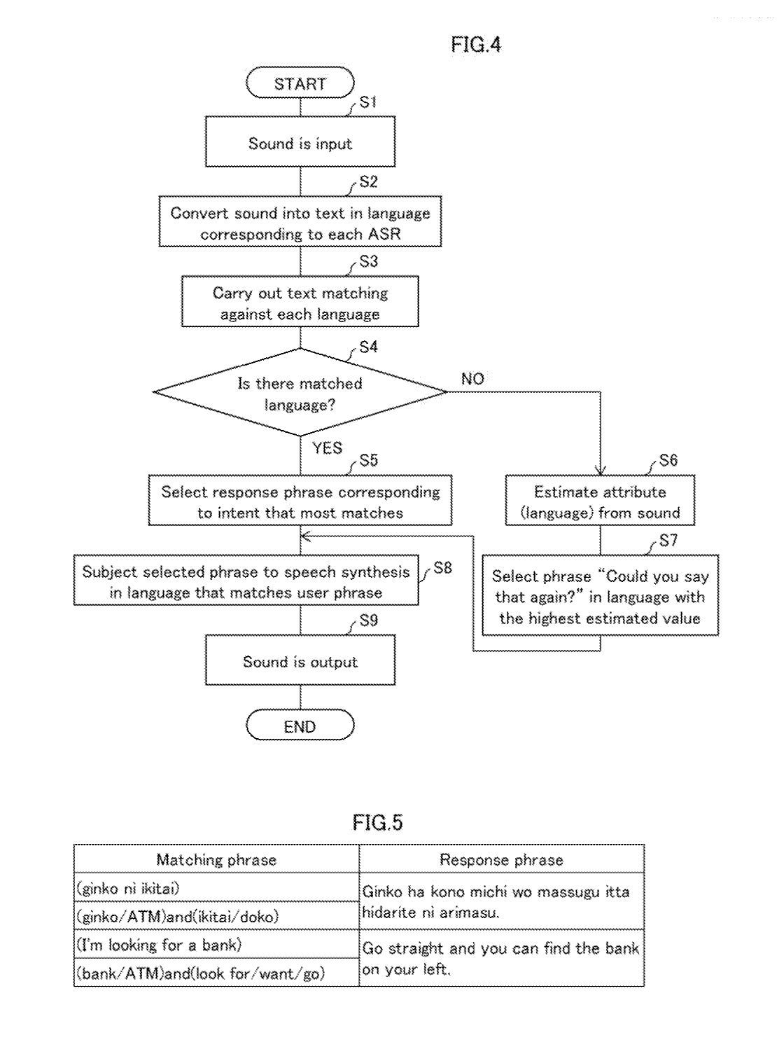

FIG. 4 is a flowchart illustrating one example of a process of information processing carried out by the information processing system 300. FIG. 5 illustrates an example of a first response group pre-stored in the first server 310.

(Step S1)

Upon input of a speech of a user to the sound input section 182 of the terminal apparatus 180, input speech information related to user's speech is transmitted to the first server 310 via the terminal's communicating section 181.

(Step S2)

The control section 320 of the first server 310 obtains the input speech information related to user's speech via the communicating section 115 (serving as a speech information obtaining section), and transmits the obtained input speech information to the second server 150 via the communicating section 115. The input speech information related to user's speech may be raw sound data such as waveform data based on a voice of the user, or may be data resulting from speech recognition, such as text information. The server control section 160 of the second server 150 converts the input speech information, which has been obtained via the communicating section 155, into a user phrase in text form through use of one of the first- to third-language ASR sections 161, 162, and 163 that corresponds to the language used by the user.

The server control section 160 of the second server 150 may be capable of calculating the degree of confidence of each user phrase when carrying out conversion into the user phrase. Alternatively, the server control section 160 may be configured to, if none of the converted user phrases have a degree of confidence greater than a predetermined threshold, determine that there are no languages that match the user phrase.

(Step S3)

The server control section 160 transmits the user phrase, which has been obtained through conversion into text form through the use of the ASR section corresponding to the language used by the user, to the first server 310 via the communicating section 155. The server control section 160 may transmit the degree of confidence of the user phrase together with the user phrase to the first server 310 via the communicating section 155. The server control section 160 may be configured to, if there are no languages that match the user phrase, transmit a notification indicating that there are no languages that match the user phrase to the first server 310 via the communicating section 155.

The control section 320 of the first server 310 carries out text matching of the user phrase in text form, which has been obtained via the communicating section 115, against first response groups in respective two or more languages, through use of the function of the response selecting section 222.

(Step S4)

The control section 320 determines, through use of the text matching function of the response selecting section 222, whether or not there is a language that matches the user phrase. If it is determined that there is a language that matches the user phrase, the control section 320 proceeds to step S5. If it is determined that there are no languages that match the user phrase, the control section 320 proceeds to step S6. Note that, if the control section 320 is notified by the second server 150 that there are not languages that match the user phrase in step S3, the control section 320 may proceed to step S6 without carrying out the text matching through use of the response selecting section 222.

(Step S5)

The control section 320 selects, through use of the function of the response selecting section 222, a first response from a first response group, according to the speech of the user and a scenario of a conversation with the user. The response selecting section 222 selects, as the first response, a response phrase that corresponds to the intent that most matches the user phrase, from the first response group.

(Step S6)

The control section 320 estimates the attribute (language) of the user through use of the function of the attribute determining section 121, with reference to the input speech information related to user's speech obtained in step S2. The estimation is made before the start of an interaction with the user, independently of the scenario of a conversation with the user.

(Step S7)

The control section 320 estimates that the language with the highest degree of language similarity (estimated value) is the language used by the user, with reference to the degree of language similarity (calculated by the attribute determining section 121) of the input speech information to each of the two or more languages. Then, the control section 320 selects a second response that prompts the user to speak again, such as the phrase “Could you say that again?”, in the language with the highest estimated value. The control section 320 may estimate the language used by the user via machine learning. The control section 320 selects the second response from a pre-stored asking response group.

Alternatively, the control section 320 may be configured to, if the response selection fails in step S5 (step of selecting response), select a response from an asking response group, which is different from the first response group, according to the result of the determination made in step S6 (step of determining attribute) (this arrangement is not illustrated).

(Step S8)

The control section 320 transmits, to the second server 150 via the communicating section 115, output speech information related to either the first response for carrying out an interaction with the user (selected in step S5) or the second response that prompts the user to speak again (selected in step S7). The server control section 160 of the second server 150 subjects the phrase obtained via the communicating section 155 to speech synthesis in the language that matches the user phrase, through use of the function of the TTS section 164.

(Step S9)

The server control section 160 transmits the output speech information, which has been subjected to speech synthesis, to the first server 310 via the communicating section 155. The control section 320 of the first server 310 transmits the output speech information, which has been obtained from the second server 150, to the terminal apparatus 180 via the communicating section 115 (serving as a speech information presenting section). The terminal apparatus 180 presents the output speech information, which has been obtained via the terminal's communicating section 181, to the user by causing the sound output section 183 to carry out streaming output of a sound of the output speech information.

It should be noted that the control section 320 of the first server 310 defines that, upon completion of the presentation of a first response included in the first response group via the communicating section 115 (serving as the speech information presenting section), an interaction between the user and the information processing system 300 started from the point in time in which the presentation was carried out. In a case where the control section 320 is to carry out a selection of a second response before the start of the interaction with the user, the control section 320 determines details of the second response according to the user's attribute determined with reference to the input speech information.

As has been described, according to the information processing system 300, if the response selecting section 222 fails to select a response, that is, if a response cannot be made in accordance with a supposed scenario, it is possible to address this by, for example, asking the user to speak again. This makes it possible, even if the intent of the user's speech cannot be specified due to a failure in speech recognition or the like, it is still possible to output an appropriate message in the language used by the user and to continue the interaction with the user.

FIG. 5 illustrates an example of a table (first response group) containing matching phrases and their corresponding response phrases, which is used when the control section 320 selects, from a response group, a response phrase that corresponds to the intent that most matches the user phrase, through use of the text matching function of the response selecting section 222. The first server 310 includes a memory section (not illustrated) that stores therein a table, an example of which is illustrated in FIG. 5. The response selecting section 222 selects a response phrase with reference to a table in which matching phrases and their corresponding response phrases are contained.

The response selecting section 222 may select the response phrase “Go straight and you can find the bank on your left” according to the degree of text similarity (edit distance) of the user phrase to, for example, the matching phrase “I'm looking for a bank”. Alternatively, the response selecting section 222 may select the response phrase “Go straight and you can find the bank on your left”, which corresponds to a scenario of a conversation with the user, based on the result of scoring to what degree the user phrase matches the matching phrase using two or more keywords such as “bank” or “ATM”, “look for” or “where”, and the like.

Alternatively, the response selecting section 222 may specify the language via text matching and select a response phrase corresponding to the specified language. For example, the response selecting section 222 may specify that the user phrase is in English, and select the response phrase “Go straight and you can find the bank on your left” according to the degree of text similarity (edit distance) of the user phrase to the matching phrase “I'm looking for a bank.” Alternatively, the response selecting section 222 may select the response phrase “Go straight and you can find the bank on your left”, which corresponds to the scenario of a conversation with the user, based on the result of scoring to what degree the user phrase matches the matching phrase using two or more keywords such as “bank” or “ATM”, “look for”, “want”, and “go”.

### Embodiment 5

The following description will discuss Embodiment 5 of the present invention. For convenience of description, members having functions identical to those of Embodiment are assigned identical referential numerals and their descriptions are omitted.

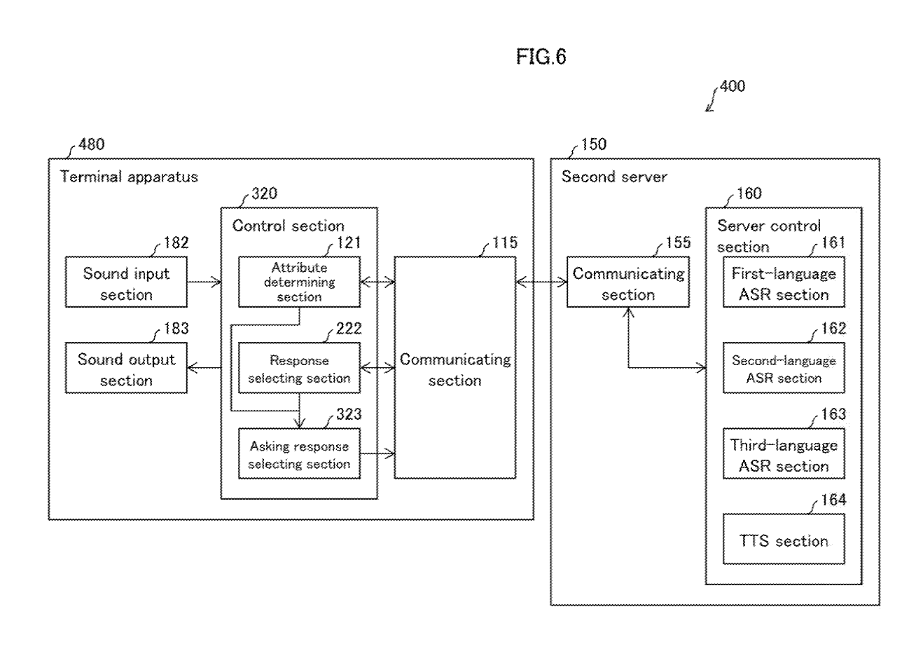

FIG. 6 is a block diagram schematically illustrating a configuration of an information processing system 400 in accordance with Embodiment 5. As illustrated in FIG. 6, the information processing system 400 is different from the information processing system 300 in accordance with Embodiment 4 in that a terminal apparatus 480 serves also as the first server 310 in accordance with Embodiment 4.

The terminal apparatus 480, which is a single apparatus, includes the sound input section 182, the sound output section 183, the control section 320, and the communicating section 115. The control section 320 obtains input speech information related to user's speech with reference to an input to the sound input section 182.

The control section 320 transmits the obtained input speech information related to user's speech to the second server 150 via the communicating section 115. The control section 320 also obtains, via the communicating section 115, input speech information which has been converted into a user phrase in text form by one of the first- to third-language ASR sections 161, 162, and 163 of the second server 150 (i.e., by an ASR section corresponding to the language used by a user).

The control section 320 carries out either one of the following processes: selecting a first response for carrying out an interaction with the user through use of the function of the response selecting section 222 with reference to the obtained input speech information related to user's speech in text form; and selecting a second response that prompts the user to speak again through use of the function of the asking response selecting section 323.

The control section 320 causes the sound output section to output a sound with reference to output speech information related to the selected first response or second response.

Alternatively, the control section 320 may be configured to, in a case of carrying out the selection of a second response before the start of the interaction with the user, determine the details of the second response according to the attribute(s) of the user determined by the attribute determining section 121 with reference to the input speech information.

The terminal apparatus 480 may also serve as the second server 150 (this arrangement is not illustrated).

According to these configurations, if the selection of a first response for carrying out an interaction with the user fails, it is possible to carry out, with the terminal apparatus 480 alone, the processes of: selecting a second response that prompts the user to speak again, according to the attribute(s) of the user; and responding to the user. This makes it possible, even if the speech recognition fails, to quickly output an appropriate message such as an asking response in the language used by the user.

### Embodiment 6

Embodiments 1 to 5 exemplarily discussed configurations in which two servers (first server 110, 210, or 310, and second server 150) are used; however, the functions of the first server 110, 210, or 310 and the second server 150 may be achieved by a single server or by two or more servers. In a case where two or more servers are used, the servers may be managed by the same business operator or by different business operators.

### Embodiment 7

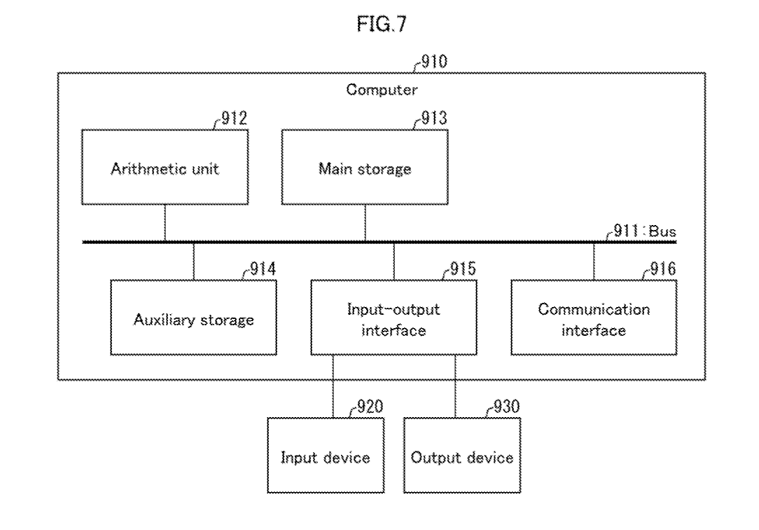

Control blocks of the first servers 110, 210, and 310, the second server 150, and the terminal apparatus 180 can each be realized by a logic circuit (hardware) provided in an integrated circuit (IC chip) or the like or can be alternatively realized by software. In the latter case, the first server 110, 210, or 310, the second server 150, and the terminal apparatus 180 can each be constituted by a computer (electronic computer) as illustrated in FIG. 7.

FIG. 7 is a block diagram exemplarily illustrating a configuration of a computer 910 that can be used as the first server 110, 210, or 310, the second server 150, or the terminal apparatus 180. The computer 910 includes an arithmetic unit 912, a main storage 913, an auxiliary storage 914, an input-output interface 915, a communication interface 916, which are connected together via a bus 911. The arithmetic unit 912, the main storage 913, and the auxiliary storage 914 may each be, for example, a processor (e.g., central processing unit (CPU)), a random access memory (RAM), or a hard disk drive. The input-output interface 915 is connected with an input device 920, via which a user inputs various kinds of information into the computer 910, and an output device 930, via which the computer 910 presents various kinds of information to the user. The input device 920 and the output device 930 may each be contained within the computer 910, or may each be connected to (provided externally to) the computer 910. The input device 920 may be, for example, a keyboard, a mouse, a touch sensor, or the like, whereas the output device 930 may be a display, a printer, a speaker, or the like. Alternatively, a device serving both as the input device 920 and the output device 930, such as a touchscreen constituted by a touch sensor and a display integrated with each other, may be employed. The communication interface 916 is an interface for communication between the computer 910 and external apparatuses.

The auxiliary storage 914 stores therein various programs for causing the computer 910 to function as the first server 110, 210, or 310, the second server 150, or the terminal apparatus 180. The arithmetic unit 912 causes the computer 910 to function as each section of the first server 110, 210, or 310, the second server 150, or the terminal apparatus 180 by loading the grogram from the auxiliary storage 914 into the main storage 913 and executing instructions of the program. Note that a storage medium which is included in the auxiliary storage 914 and which stores therein information such as programs may be any medium, provided that the storage medium is a computer-readable “non-transitory tangible medium”, and may be, for example, a tape, a disk, a card, a semiconductor memory, a programmable logic circuit, or the like. In a case where the computer 910 is capable of executing the programs stored in the storage medium without loading the programs into the main storage 913, the main storage 913 may be omitted. The number of devices of each kind (the arithmetic unit 912, the main storage 913, the auxiliary storage 914, the input/output interface 915, the communication interface 916, the input device 920, and the output device 930) may be one or two or more.

The computer 910 may externally obtain each of the foregoing programs. In this case, the program may be obtained via any transmission medium (such as a communication network or a broadcast wave). The present invention can also be achieved in the form of a computer data signal in which the program is embodied via electronic transmission and which is embedded in a carrier wave.

[Recap]

An information processing apparatus (first server 110) in accordance with Aspect 1 of the present invention includes a communicating section (115) and a control section (320), the control section (320) being configured to obtain input speech information related to a speech of a user via the communicating section (115), select a first response or a second response with reference to the input speech information thus obtained, the first response being a response for carrying out an interaction with the user, the second response being a response for prompting the user to speak again, and present, via the communicating section (115), output speech information related to the first or second response thus selected, the control section (320) being configured to, if selection of the second response is to be carried out before start of the interaction with the user, determine a detail of the second response according to an attribute of the user determined with reference to the input speech information.

According to the above configuration, if the selection of a first response for carrying out an interaction with the user fails, a second response for prompting the user to speak again is selected according to the result of the attribution determination. This makes it possible, even if the speech recognition fails, to output an appropriate message such as an asking response in the language the user used.

An information processing apparatus (first server 110) in accordance with Aspect 2 of the present invention is configured such that, in Aspect 1, the attribute is at least one of a language used by the user and a hometown of the user.

The above configuration makes it possible, even if the speech recognition fails, to output a message which is an asking response corresponding to the hometown of the user in the language used by the user.

An information processing apparatus (first server 110) in accordance with Aspect 3 of the present invention is configured such that, in Aspect 2, the attribute is at least one of an age of the user and a gender of the user.

The above configuration makes it possible, even if the speech recognition fails, to output a message which is an asking response corresponding to at least one of the age of the user and the gender of the user.

An information processing apparatus (first server 110) in accordance with Aspect 4 of the present invention includes: a speech information obtaining section (communicating section 115) configured to obtain input speech information related to a speech of a user; a response selecting section (122, 123, 124) configured to select a first response or a second response with reference to the input speech information thus obtained, the first response being a response for carrying out an interaction with the user, the second response being a response for prompting the user to speak again; and a speech information presenting section (communicating section 115) configured to present output speech information related to the first or second response thus selected, the response selecting section (122, 123, 124) being configured to, if selection of the second response is to be carried out before start of the interaction with the user, determine a detail of the second response according to an attribute of the user determined with reference to the input speech information.

According to the above configuration, if the selection of a first response for carrying out an interaction with the user fails, a second response for prompting the user to speak again is selected according to the result of the attribution determination. This makes it possible, even if the speech recognition fails, to output an appropriate message such as an asking response in the language the user used.

A terminal apparatus (180) in accordance with Aspect 5 of the present invention includes a sound input section (182), a sound output section (183), and a control section, the control section being configured to obtain input speech information related to a speech of a user with reference to an input to the sound input section, select a first response or a second response with reference to the input speech information thus obtained, the first response being a response for carrying out an interaction with the user, the second response being a response for prompting the user to speak again, and cause the sound output section to output a sound with reference to the output speech information related to the first or second response thus selected, the control section being configured to, if selection of the second response is to be carried out before start of the interaction with the user, determine a detail of the second response according to an attribute of the user determined with reference to the input speech information.

According to the above configuration, if the selection of a first response for carrying out an interaction with the user fails, a second response for prompting the user to speak again is selected according to the attribute of the user. This makes it possible, even if the speech recognition fails, to output an appropriate message such as an asking response in the language the user used.

An information processing system (300) in accordance with Aspect 6 of the present invention includes: an information processing apparatus (first server 310) including a communicating section (115) and a control section (320); and a terminal apparatus (180) including a sound input section (182), a sound output section (183), a terminal's communicating section (181), and a terminal control section (185), the terminal control section (185) being configured to obtain input speech information related to a speech of a user with reference to an input to the sound input section (182), and transmit the input speech information via the terminal's communicating section (181), the control section (320) being configured to obtain the input speech information via the communicating section (151), select a first response or a second response with reference to the input speech information thus obtained, the first response being a response for carrying out an interaction with the user, the second response being a response for prompting the user to speak again, and transmit, via the communicating section (151), output speech information related to the first or second response thus selected, the terminal control section (185) being configured to obtain the output speech information via the terminal's communicating section (181), and cause the sound output section (183) to output a sound with reference to the output speech information thus obtained, the control section (320) being configured to, if selection of the second response is to be carried out before start of the interaction with the user, determine a detail of the second response according to an attribute of the user determined with reference to the input speech information.

According to the above configuration, if the selection of a first response for carrying out an interaction with the user fails, a second response for prompting the user to speak again is selected according to the result of the attribution determination. This makes it possible, even if the speech recognition fails, to output an appropriate message such as an asking response in the language the user used.

The first server 110, 210, or 310, the second server 150, or the terminal apparatus 180 according to one or more embodiments of the present invention may be realized by a computer. In this case, the present invention encompasses: a control program for the first server 110, 210, or 310, the second server 150, or the terminal apparatus 180 which program causes a computer to operate as the foregoing sections (software elements) of the first server 110, 210, or 310, the second server 150, or the terminal apparatus 180 so that the first server 110, 210, or 310, the second server 150, or the terminal apparatus 180 can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

100, 200, 300 Information processing system
110, 210, 310 First server (information processing apparatus)
150 Second server
120, 220, 320 Control section
121 Attribute determining section
122 First-language response selecting section
123 Second-language response selecting section
124 Third-language response selecting section
164 TTS section
180 Terminal apparatus
182 Sound input section
183 Sound output section
222, 323 Response selecting section
161 First-language ASR section
162 Second-language ASR section
163 Third-language ASR section

1. An information processing apparatus comprising a communicating section and a control section,
the control section being configured to
obtain input speech information related to a speech of a user via the communicating section,
select a first response or a second response with reference to the input speech information thus obtained, the first response being a response for carrying out an interaction with the user, the second response being a response for prompting the user to speak again, and
present, via the communicating section, output speech information related to the first or second response thus selected,
the control section being configured to, if selection of the second response is to be carried out before start of the interaction with the user, determine a detail of the second response according to an attribute of the user determined with reference to the input speech information.

2. The information processing apparatus according to claim 1, wherein
the attribute is
at least one of a language used by the user and a hometown of the user.

3. The information processing apparatus according to claim 1, wherein
the attribute is
at least one of an age of the user and a gender of the user.

4. An information processing apparatus comprising:
a speech information obtaining section configured to obtain input speech information related to a speech of a user;
a response selecting section configured to select a first response or a second response with reference to the input speech information thus obtained, the first response being a response for carrying out an interaction with the user, the second response being a response for prompting the user to speak again; and
a speech information presenting section configured to present output speech information related to the first or second response thus selected,
the response selecting section being configured to, if selection of the second response is to be carried out before start of the interaction with the user, determine a detail of the second response according to an attribute of the user determined with reference to the input speech information.

5. A terminal apparatus comprising a sound input section, a sound output section, and a control section,
the control section being configured to
obtain input speech information related to a speech of a user with reference to an input to the sound input section,
select a first response or a second response with reference to the input speech information thus obtained, the first response being a response for carrying out an interaction with the user, the second response being a response for prompting the user to speak again, and
cause the sound output section to output a sound with reference to the output speech information related to the first or second response thus selected,
the control section being configured to, if selection of the second response is to be carried out before start of the interaction with the user, determine a detail of the second response according to an attribute of the user determined with reference to the input speech information.

6. An information processing system comprising:
an information processing apparatus including a communicating section and a control section; and
a terminal apparatus including a sound input section, a sound output section, a terminal's communicating section, and a terminal control section,
the terminal control section being configured to
obtain input speech information related to a speech of a user with reference to an input to the sound input section, and
transmit the input speech information via the terminal's communicating section,
the control section being configured to
obtain the input speech information via the communicating section,
select a first response or a second response with reference to the input speech information thus obtained, the first response being a response for carrying out an interaction with the user, the second response being a response for prompting the user to speak again, and
transmit, via the communicating section, output speech information related to the first or second response thus selected,
the terminal control section being configured to
obtain the output speech information via the terminal's communicating section, and
cause the sound output section to output a sound with reference to the output speech information thus obtained,
the control section being configured to
if selection of the second response is to be carried out before start of the interaction with the user, determine a detail of the second response according to an attribute of the user determined with reference to the input speech information.

7. An information processing method comprising:
a response selecting step including carrying out a selection of a response included in a first response group according to a speech of a user and a scenario of a conversation with the user;
an attribute determining step including determining an attribute of the user independently of the scenario of the conversation with the user; and
an asking response selecting step including, if the selection of a response in the response selecting step fails, selecting a response included in an asking response group according to a result of determination in the attribute determining step, the asking response group being different from the first response group.

8. A computer-readable storage medium storing therein an information processing program for causing a computer to function as the information processing apparatus recited in claim 1, the information processing program causing the computer to function as the control section.
